(19) United States
(12) Patent Application Publication
(10) Pub. No.: US 2010/0186981 A1
(43) Pub. Date: Jul. 29, 2010

(54) Wind turbine junction box having individual run

(76) Inventors: Evan V. Thomas, West Chester, OH (US); James R. Moorman, Oregonia, OH (US)

Correspondence Address: HOLLAND & KNIGHT LLP, 2099 PENNSYLVANIA AVE, SUITE 100, WASHINGTON, DC, 20006, US

(21) Appl. No.: 12/321,847

(22) Filed: Jan. 27, 2009

(51) Int. Cl. H02G 3/08; F03D 11/00; H01R 3/00

(52) U.S. Cl. 174/50; 416/146 R; 439/491

(57) ABSTRACT

A wind turbine junction box having an individual run is provided having a housing and an electrical circuit connection means. The housing has a top surface, a bottom member, a rear wall and two side walls on opposite ends of the rear wall, with the rear wall and the side walls being in contacting relationship with the top surface and the bottom member. The top surface has a plurality of apertures formed therein in an individual run on an axis that extends between the side walls. The housing has an interior with at least one door accessing the interior. The electrical circuit connection means includes a non-conductive cross beam having first and second ends, each of the first and second ends of the cross beam being secured to one of the housing side walls. Electrical connectors are secured to the cross beam, with each of the electrical connectors oriented along an axis that extends from the top to the bottom of the housing.

### BACKGROUND OF THE INVENTION

1. Field of the Invention

This invention relates generally to junction boxes, and more particularly, to a wind turbine junction box, with the junction box featuring an individual run instead of phased runs.

2. Description of the Related Art

This invention is directed to the providing of an electrical junction box to enclose the joined cables associated with wind turbines. Wind turbines are sometimes referred to as windmills, but the power generated by them is many times that of the windmills seen on rural farms in the twentieth century. Modern wind turbines can be over 200 feet high and provide over 2.5 megawatts of electricity. Wind turbines are being touted as one way to reduce dependence on oil, while at the same time reducing air pollution.

One problem associated with wind turbines is caused by their height. While taller turbines can produce more electricity due to the air currents several hundred feet above ground, the energy that is harnessed by the blades must be transmitted downwardly through the interior of the structure by way of wire cables. Due to the size and weight of these cables, each cable pathway has been created by attaching a plurality of cables to one another vertically in series. Furthermore, there are typically several (i.e. 3-5) cables secured to one another in phased runs, so for example if 18 cables descend from the top to the bottom of a wind turbine tower, they are typically bundled in three groups (phases) of 5 cables and one group of 3 cables. The direction of the phases extends between the front and back of the housing in which the cables are connected.

Until recently, the prior art of wind turbines typically has had each individual cable attached to the next adjacent cable above or below it by means of a copper compression splice, with one end of the compression splice in direct contact with the cable descending from above the splice and with the other end of the compression splice in direct contact with the cable that descends below the copper compression splice. The area of the splice in then typically wrapped with a plastic sheet-form member to theoretically provide some degree of insulation.

This means of attachment results in a significant amount of heat being generated at the site of the splice, which in turn is detrimental to the electrical circuit. Due to the type of splice used to connect the adjacent wire cables in the prior art, the circuits had a tendency to break down, which associated with unintentionally redistributing the electrical power into the remaining cables, caused the other downwardly extending cables within the tower to undergo greater stress than was originally intended. Consequently, this stress could cause other of the remaining cables to degrade.

Additionally, in the prior art of wind turbines, since the cables were positioned in phased runs, the cabinet in which the connections were made had to be of a depth to accommodate the plurality of cables. However, heretofore there has not been a junction box having an individual phase run which also would conserve space inside the tower since the junction box would not need to be as deep.

It is thus apparent that the need exists for a better way to join the wire cables used in wind turbines.

### SUMMARY OF THE INVENTION

In accordance with the present invention, there is disclosed a wind turbine junction box having an individual run, with the junction box having a housing and an electrical circuit connection means. The housing has a top surface, a bottom member, a rear wall and two side walls on opposite ends of the rear wall, with the rear wall and the side walls being in contacting relationship with the top surface and the bottom member. The top surface has a plurality of apertures formed therein in an individual run on an axis that extends between the side walls. The housing has an interior, with the housing having at least one door accessing the interior.

The electrical circuit connection means includes a non-conductive cross beam having first and second ends, each of the first and second ends of the cross beam being secured to one of the housing side walls. The electrical circuit connection means also includes electrical connectors secured to the cross beam, each electrical connector oriented along a axis that extends from the top to the bottom of the housing.

Preferably, the electrical circuit connection means includes a plurality of vertical insulation members secured perpendicularly in spaced relationship to the cross beam. The vertical insulation members are preferably of a C-channel shape with two side channel walls and a rear channel wall, the rear channel wall of each of the vertical insulation members being in contacting relationship with the cross beam. The apertures formed in said top surface are of a diameter to facilitate the passage therethrough of the electrical cable for a circuit of a wind turbine. The top surface has a plurality of indicia thereon, each of the indicia being associated with a corresponding aperture in the top surface, with the indicia indicating the type of electrical circuit passing through each top surface aperture.

An electrical connector is attached to each vertical insulation member and another electrical connector is attached to the cross beam intermediate each vertical insulation member, so that each vertical insulation member has an electrical connector attached to it and with an electrical connector attached to the cross beam intermediate each vertical insulation member.

Each aperture in the top surface has associated therewith and in contacting relationship thereto a plastic grommet. Similarly, each aperture in the bottom member has associated therewith and in contacting relationship thereto a plastic grommet. Preferably, each cross beam is a C-shaped channel with a top horizontal wall, a bottom horizontal wall, and an intermediate wall connecting the top horizontal wall and the bottom horizontal wall, with the intermediate wall being in contacting relationship with electrical connectors.

There is also disclosed a wind turbine junction box having an individual run, with the junction box having a housing an electrical circuit connection means. The housing has a top surface, a bottom member, a rear wall and two side walls on opposite ends of the rear wall, with the rear wall and the side walls being in contacting relationship with the top surface and the bottom member. The top surface has a plurality of apertures formed therein in an individual run on an axis that extends between the side walls. The housing has an interior, with the housing having at least one door accessing the interior.

The electrical circuit connection means includes a non-conductive cross beam having first and second ends, with each of said first and second ends of the cross beam being secured to one of the housing side walls, a plurality of vertical insulation members secured perpendicularly in spaced relationship to the cross beam, and electrical connectors secured to the cross beam. Each electrical connector is oriented along a axis that extends from the top to the bottom of the housing.

The vertical insulation members are preferably of a C-channel shape with two side channel walls and a rear channel wall, with the rear channel wall of each of the vertical insulation members being in contacting relationship with the cross beam. The apertures formed in the top surface are of a diameter to facilitate the passage therethrough of the electrical cable for a circuit of a wind turbine. The top surface has a plurality of indicia thereon, each of the indicia being associated with a corresponding aperture in the top surface, with each respective indicia indicating the type of electrical circuit passing through each corresponding top surface aperture.

Each electrical connector is either attached to a vertical insulation member or to the cross beam intermediate a pair of vertical insulation members. Each aperture in the top surface preferably has associated therewith and in contacting relationship thereto a plastic grommet, and each aperture in the bottom member preferably has associated therewith and in contacting relationship thereto a plastic grommet. Preferably, the cross beam is a C-shaped channel with a top horizontal wall, a bottom horizontal wall, and an intermediate wall connecting the top horizontal wall and the bottom horizontal wall, with the intermediate wall being in contacting relationship with the electrical connectors.

The primary objective of this invention is to provide a better way to join the wire cables used in wind turbines so that the degradation of the electrical circuits inside the tower of the wind turbine is significantly lessened.

Another objective of this invention is to provide such a device that keeps persons inside the tower of the wind turbine safer when they are around the wire cables, given the current flowing therethrough.

Still another objective is to provide such a device that is relatively easy to install in existing wind turbine towers or incorporate into new wind turbine towers, thereby minimizing electrical circuit degradation and enhancing safety.

Other objects and advantages of the invention will be apparent from the following description, the accompanying drawings and the appended claims.

### BRIEF DESCRIPTION OF THE DRAWINGS

FIG. 1 is a perspective view of a wind turbine junction box made in accordance with this invention.

FIG. 2 is a perspective view of the sidewall housing of this invention.

FIG. 3 is a perspective view of the top cover component of the invention.

FIG. 4 is a perspective view of the bottom tray component of the invention.

FIG. 5 is a front elevational view of the invention with the door removed.

FIG. 6 is a vertical sectional view taken along line 6-6 of FIG. 5.

FIG. 7 is a horizontal sectional view taken along line 7-7 of FIG. 5.

FIG. 8 is a top plan view on a greatly enlarged scale taken along line 8-8 of FIG. 7.

FIG. 9 is an exploded perspective view of the lay-in connector of the invention.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

This invention addresses the above limitations associated with prior art wind turbines resulting in a wind turbine junction box that can especially be utilized in small wind turbines where interior tower space is limited. Erected wind turbines comprise several floors within the tower of the structure, with each floor level having a hatch or door mechanism formed in the floor to enable access to higher floor levels. By opening these hatches, the components of the wiring circuit can be passed through the openings in the floor, until they can be assembled into a junction box which is attached to the wall of the tower preferably by means of a bracket member.

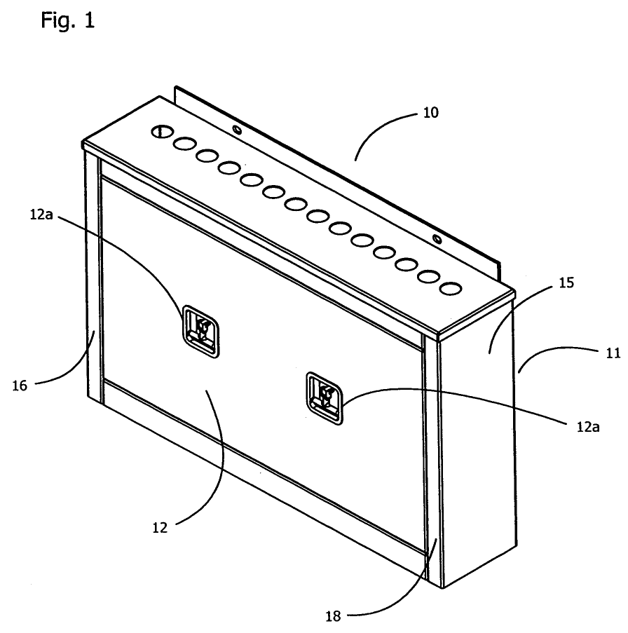

Having reference to the drawings, attention is directed first to FIG. 1, which discloses the junction box of the invention once assembled, with the junction box being designated generally by the numeral 10. As can be appreciated, the junction box includes a housing 11 and a door 12. Due to space limitations in smaller wind turbine towers, the door shown features a recessed T-handle 12a of the type well known in the art of electrical cabinets and junction boxes. The incorporation of a recessed T-handle door permits the door to be lifted away from the housing when access to the interior 28 of the junction box is required. The use of a recessed T-handle door would be preferred in smaller wind turbines, but other types of doors, such as single or double doors on hinges could be used and installed as is well known in the art.

The housing is preferably fabricated using all welded construction and has a rear wall 13, a first side wall 14, and a second side wall 15 on the opposite side from the first side wall. The first side wall and second side wall are both attached to and directly adjacent the rear wall, with all three surfaces being rectangular in shape. As can be appreciated from a comparison of FIGS. 1, 2 and 5, the front of the junction box has a first vertical front wall component 16 with inwardly extending flange 17, and a second vertical front wall component 18 with inwardly extending flange 19. Extending inwardly from the lower edges of at least the two side walls of the housing and the rear wall, if not the portions of the front of the housing where the first and second vertical front wall components are located, is bottom inwardly extending member 20 which could be formed as one or as a plurality of flanges upon which the bottom 40 of the junction box rests, essentially as a tray member. Along the inner edge of the inwardly extending flanges 17, 19 extend door stops 21, 23 respectively, these door stops being in the same vertical plane with each other, and perpendicular to the inwardly extending flanges 17, 19.

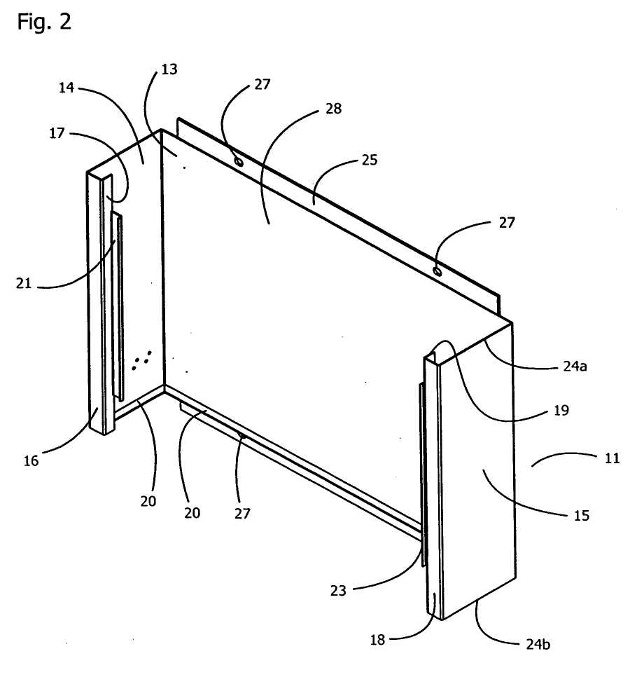

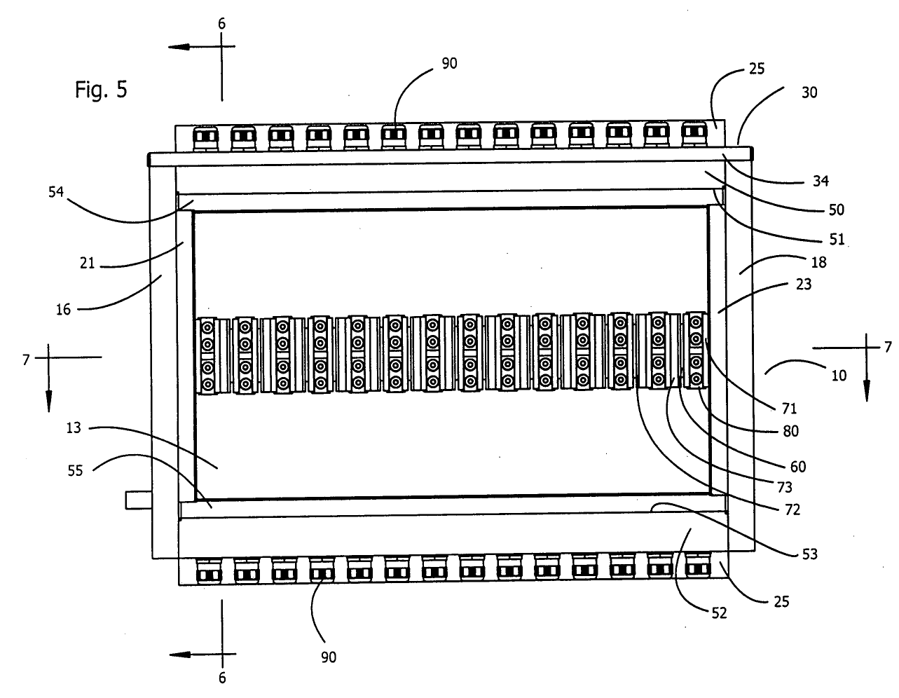

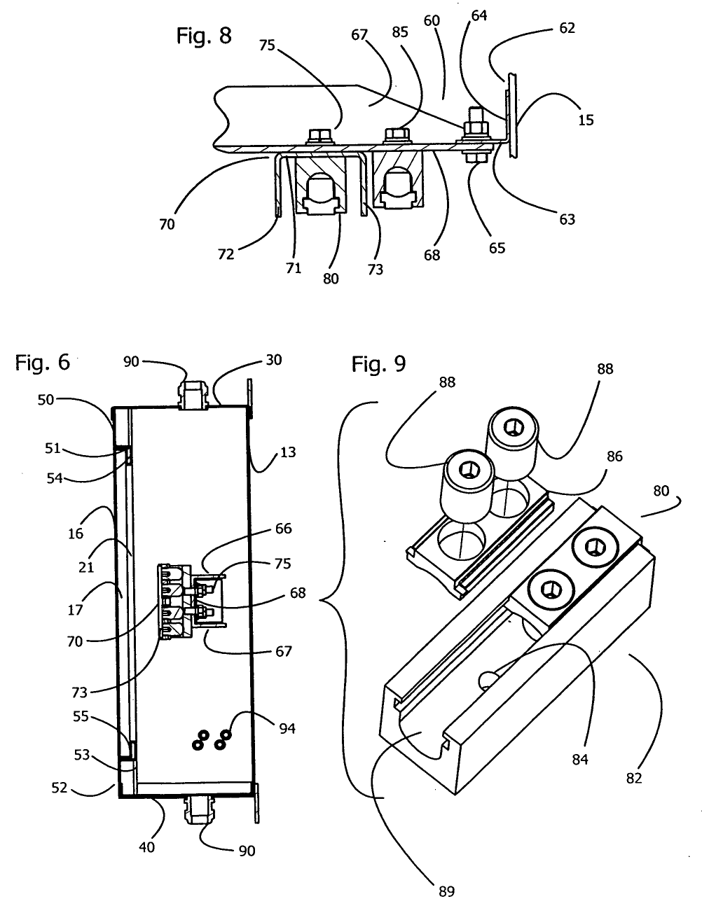

As can best be seen in FIG. 2, around the perimeter of the top of the housing is a housing top edge 24a. Similarly, around the perimeter of the bottom of the housing is housing bottom edge 24b. As can be appreciated from a comparison of FIGS. 5 and 6, an attachment plate 25 is secured to the rear wall of the housing, such that it extends above the housing so that attachment apertures 27 can be used to secure the junction box to the wind tower. An additional attachment plate 25 is located along the bottom of the housing, being secured to the exterior surface of the rear wall. This attachment plate 25 also has attachment apertures for securing the junction box to the wind tower by use of suitable fastening means.

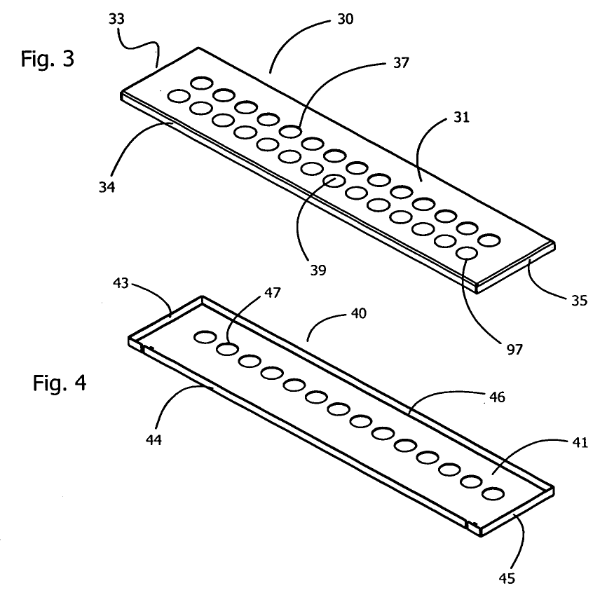

As can be appreciated from a comparison of FIGS. 1, 3, 5, and 6, the junction box is provided with a top 30 having an outer surface 31. The top has a first downwardly extending flange 33, a second downwardly extending flange 34, and a third downwardly extending flange 35 that overlaps the uppermost section of first side wall, the vertical front wall components, and the second side wall. The top 30 rests on the upper edge of the housing and may be secured by welding to the outer side surfaces of the housing.

It will be noted that a plurality of top apertures 37 forms a single row of individual runs that extends along an axis generally parallel to the elongated axis of the rear wall, with this single row being almost midway between the front and back of the cover. Intermediate the top apertures 37 and the second downwardly extending flange 34 are a series of top indicia 39, preferably in a row as well, with the indicia preferably being color-coded to correspond to the type of cable to be inserted into that particular aperture in the junction box.

The junction box is also provided with a bottom 40, which is similar to a tray that is laid onto the bottom inwardly extending members 20 and preferably secured thereto. The bottom has an inner surface 41, and a first upwardly extending flange 43, a second upwardly extending flange 44, a third upwardly extending flange 45, and a fourth upwardly extending flange 46 as can best be appreciated from a comparison of FIGS. 1 and 6. These four flanges extend upwardly directly adjacent to the side walls, rear wall and front wall of the housing at adjacent the housing bottom edge 24b.

It will be noted that a plurality of bottom apertures 47 forms a single row of individual runs that extends along an axis generally parallel to the elongated axis of the rear wall, with this single row being almost midway between the front and back of the cover, as well as directly below the top apertures 37. Intermediate the bottom apertures 47 and the second upwardly extending flange 44 are a series of bottom indicia (not shown), preferably in a row as well, with the indicia preferably being color-coded to correspond to the type of cable to be inserted into that particular aperture in the junction box.

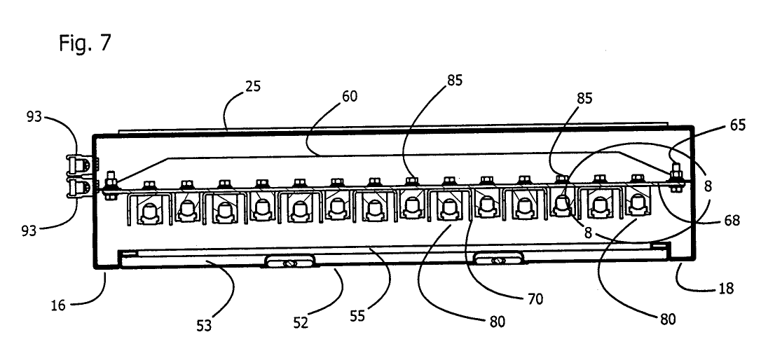

As can be appreciated from a comparison of FIGS. 1, 2, 5, 6, and 7, the front wall of the junction box is formed from several members in addition to the two vertical front wall components, one of which is a first horizontal front wall component 50. This component spans the gap at the top of the front wall between the two vertical front wall components, and helps provide a frame for the door 12. An inwardly extending flange 51 extends inwardly from the lower edge of the first horizontal front wall component towards the interior of the housing in a horizontal plane. At the bottom of the front of the junction box is a second horizontal front wall component 52. This component spans the gap at the bottom of the front wall between the two vertical front wall components, and also helps provide a frame for the door 12. An inwardly extending flange 53 extends inwardly from the top edge of the second horizontal front wall component towards the interior of the housing in a horizontal plane. Extending downwardly from the innermost edge of the first horizontal front wall component inwardly extending flange 51 is door stop 54. Similarly, extending upwardly from the innermost edge of the second horizontal front wall component inwardly extending flange 53 is door stop 55.

As can be appreciated from a comparison of FIGS. 5, 6, 7, and 8, an insulated cross beam 60 is provided. Preferably this is C-shaped in cross-section and fabricated from a non-conductive material such as Glastic®, a product of Glastic Corp. The cross beam is attached to the opposite side walls of the housing by cross beam attachment means 62, best shown in FIG. 8, and with each attachment means being a piece of right-angled metal, having a first surface 63 that overlaps a section of the cross beam to facilitate attachment thereto. Each cross beam attachment means 62 also has a second surface 64 that is parallel and directly adjacent a side wall of the housing to which it is preferably welded. The first surface 63 has an aperture through which cross beam fastening means 65 is inserted to permit the cross beam (which also has an aperture to accommodate the fastening means) to be secured across the interior of the housing in a horizontal plane. The cross beam has a top surface 66 which is horizontal, a bottom surface 67 which is also horizontal, and an intermediate surface 68 which is vertical and attached at its top and bottom to the top surface 66 and bottom surface 67 respectively.

The electrical circuit connection means preferably also has a vertical insulation channel 70 as can best be appreciated from a comparison of FIGS. 6, 7, and 8. It too is preferably formed from a non-conductive material such as Glastic®, and has a C-shape with a rear wall 71, a first side wall 72, and a second side wall 73. The rear wall 71 is secured to the cross beam by screwing vertical insulation channel attachment means 75 through an aperture (not shown) in the vertical intermediate surface of the cross beam and an aperture (not shown) in the vertical insulation channel surface into the back of lay-in connector 80.

The lay-in connector 80 used in this invention is well known in the electrical trade. It has a base member 82 with a pair of attachment apertures 84 into which the vertical insulation channel attachment means 75 or lay-in connector attachment means 85 are inserted. The lay-in connector 80 has a lay-in nut 86 having apertures therein for insertion therein of a lay-in nut attachment means, which also serves to grip the cable that extends through the trough 89 of the lay-in connector. The lay-in connectors are separated from each other by a non-conductive wall, in this embodiment a side wall of the vertical insulation channel, although single walls could be attached between each lay-in connector. Thus, as shown, there are twice as many lay-in connectors as there are vertical insulation channels.

The junction box also includes plastic grommets (known in the trade as PGs) 90 at the top apertures 37 and the bottom apertures 47 in the manner well known in the art. The junction box also includes ground lug assemblies 93 of the type well known in the art, with these assemblies permitting the insertion therein of two grounding cables for the wind turbine. The ground lug assemblies attachment apertures 94 are shown as being offset in the manner well known in the prior art.

In actual use, the junction box of this invention can be assembled inside a wind turbine tower at a predetermined floor location. It may be necessary for a junction box to be assembled for each floor inside the tower, such that several of the containers of this invention may be located inside a single wind turbine tower. The sidewalls of the cabinet are secured to the interior wall of the tower preferably by attachment to a bracket that is secured directly to the wall of the tower. Cables are passed through the apertures in the top and bottom of the cabinet, with indicia on both the top and bottom of the junction box to assist in the running of the cable. The cable is then secured to the appropriate compression lug attached to the cross bar. As shown in the drawing figures, in this particular embodiment of the invention a single row of cables pass through the cabinet, with the last two apertures being provided to accommodate cables for the neutral ground. The door of the cabinet is then closed, resulting in the electrical circuit connections being impossible for a worker to inadvertently come into contact with while inside the tower.

A key aspect of this invention is that the cabinet provides a better way to join the wire cables used in wind turbines, so that the degradation of the electrical circuits inside the tower of the wind turbine is significantly lessened.

Another key aspect of this invention is that the cabinet keeps persons inside the tower of the wind turbine safer when they are around the wire cables, given the current flowing therethrough.

While the form of apparatus herein described constitutes a preferred embodiment of the present invention, it is to be understood that the invention is not limited to this precise form of apparatus and that changes may be made therein without departing from the scope of the invention which is defined in the appended claims.

What is claimed is:

1. A wind turbine junction box having an individual run comprising
a housing, said housing having a top surface, a bottom member, a rear wall and two side walls on opposite ends of said rear wall, said rear wall and said side walls being in contacting relationship with said top surface and said bottom member, said top surface having a plurality of apertures formed therein in an individual run on an axis that extends between said side walls, said housing having an interior, said housing having at least one door accessing said interior, and
an electrical circuit connection means, said connection means including a non-conductive cross beam having first and second ends, each of said first and second ends of said cross beam being secured to one of said housing side walls, and electrical connectors secured to said cross beam, each said electrical connector oriented along a axis that extends from the top to the bottom of said housing.

2. The junction box according to claim 1 wherein said electrical circuit connection means includes a plurality of vertical insulation members secured perpendicularly in spaced relationship to said cross beam.

3. The junction box according to claim 2 wherein said vertical insulation members are of a C-channel shape with two side channel walls and a rear channel wall, said rear channel wall of each of said vertical insulation members being in contacting relationship with said cross beam.

4. The junction box according to claim 1 wherein said apertures formed in said top surface are of a diameter to facilitate the passage therethrough of the electrical cable for a circuit of a wind turbine.

5. The junction box according to claim 1 wherein said top surface has a plurality of indicia thereon, each of said indicia being associated with a corresponding aperture in said top surface, said indicia indicating the type of electrical circuit passing through each said top surface aperture.

6. The junction box according to claim 2 wherein an electrical connector is attached to each vertical insulation member and an electrical connector is attached to said cross beam intermediate each vertical insulation member.

7. The junction box according to claim 1 wherein each aperture in said top surface has associated therewith and in contacting relationship thereto a plastic grommet.

8. The junction box according to claim 1 wherein each aperture in said bottom member has associated therewith and in contacting relationship thereto a plastic grommet.

9. The junction box according to claim 1 wherein each said cross beam is a C-shaped channel with a top horizontal wall, a bottom horizontal wall, and an intermediate wall connecting said top horizontal wall and said bottom horizontal wall, said intermediate wall being in contacting relationship with said electrical connectors.

10. A wind turbine junction box having an individual run comprising
a housing, said housing having a top surface, a bottom member, a rear wall and two side walls on opposite ends of said rear wall, said rear wall and said side walls being in contacting relationship with said top surface and said bottom member, said top surface having a plurality of apertures formed therein in an individual run on an axis that extends between said side walls, said housing having an interior, said housing having at least one door accessing said interior, and
an electrical circuit connection means, said connection means including a non-conductive cross beam having first and second ends, each of said first and second ends of said cross beam being secured to one of said housing side walls, a plurality of vertical insulation members secured perpendicularly in spaced relationship to said cross beam, and electrical connectors secured to said cross beam, each said electrical connector oriented along a axis that extends from the top to the bottom of said housing.

11. The junction box according to claim 10 wherein said vertical insulation members are of a C-channel shape with two side channel walls and a rear channel wall, said rear channel wall of each of said vertical insulation members being in contacting relationship with said cross beam.

12. The junction box according to claim 10 wherein said apertures formed in said top surface are of a diameter to facilitate the passage therethrough of the electrical cable for a circuit of a wind turbine.

13. The junction box according to claim 10 wherein said top surface has a plurality of indicia thereon, each of said indicia being associated with a corresponding aperture in said top surface, said indicia indicating the type of electrical circuit passing through each said top surface aperture.

14. The junction box according to claim 10 wherein an electrical connector is attached to each vertical insulation member and an electrical connector is attached to said cross beam intermediate each vertical insulation member.

15. The junction box according to claim 10 wherein each aperture in said top surface has associated therewith and in contacting relationship thereto a plastic grommet, and each aperture in said bottom member has associated therewith and in contacting relationship thereto a plastic grommet.

16. The junction box according to claim 10 wherein each said cross beam is a C-shaped channel with a top horizontal wall, a bottom horizontal wall, and an intermediate wall connecting said top horizontal wall and said bottom horizontal wall, said intermediate wall being in contacting relationship with said electrical connectors.
